(19) United States
(12) Patent Application Publication
(10) Pub. No.: US 2006/0193992 A1
(43) Pub. Date: Aug. 31, 2006

(54) Method and system for controlling a substrate position in an electrochemical process

(76) Inventors: Matthias Bonkass, Dresden (DE); Axel Preusse, Radebeul (DE); Markus Nopper, Dresden (DE)

Correspondence Address: WILLIAMS, MORGAN & AMERSON, 10333 RICHMOND, SUITE 1100, HOUSTON, TX, 77042, US

(21) Appl. No.: 11/212,048

(22) Filed: Aug. 25, 2005

(30) Foreign Application Priority Data
Feb. 28, 2005 (DE) 10 2005 009 024.9

(51) Int. Cl. B05D 1/18; B05C 11/00; B05C 19/02

(52) U.S. Cl. 427/430.1; 118/686; 118/423; 118/429; 118/426

(57) ABSTRACT

By using signals from an electric drive assembly of an electroplating tool, the operating position of the substrate surface to be plated may be determined in an automated fashion wherein, based on a reference position, the meniscus of the electrolyte and/or any appropriate operating position may be determined. Consequently, accuracy and throughput may be enhanced compared to conventional manual or semi-automatic adjustment procedures.

### BACKGROUND OF THE INVENTION

1. Field of the Invention

The present invention relates to the electrochemical treatment of a surface of a substrate used for forming micro-structural features, such as circuit elements of integrated circuits, using a reactor for electroplating or electroless plating or electropolishing, and, more particularly, to adjusting a position of the substrate surface within the reactor.

2. Description of the Related Art

In many technical fields, the electrochemical treatment of a substrate surface, such as the deposition of metal layers on and/or the removal of metal from the substrate surface, is a frequently employed technique. For example, for efficiently depositing relatively thick metal layers on a substrate surface, plating, in the form of electroplating or electroless plating, has proven to be a viable and cost-effective method and, thus, electroplating has become, in addition to other fields, such as the printed circuit board industry, an attractive deposition method in the semiconductor industry.

Recently, copper has become a preferred candidate in forming metallization layers in sophisticated integrated circuits, due to the superior characteristics of copper and copper alloys in view of conductivity and resistance to electromigration compared to, for example, the commonly used aluminum. Since copper may not be deposited very efficiently by physical vapor deposition, for example by sputter deposition, with a layer thickness on the order of 1 μm and more, electroplating of copper and copper alloys is presently a preferred deposition method in forming metallization layers. Although electroplating of copper is a well-established technique in various fields, reliably depositing copper over large diameter wafers having a patterned surface including trenches and vias, is a challenging task for process engineers. For example, forming a metallization layer of an ultra-large scale integration device requires the reliable filling of wide trenches with a width on the order of hundreds of nanometers or some micrometers and also requires the filling of vias and trenches having a diameter or width of 0.1 μm or even less. The situation gains even more in complexity as the diameters of the substrates tend to increase. Currently, eight or even ten or twelve inch wafers are commonly used in a semiconductor process line. Thus, great efforts are being made in the field of copper plating to provide the copper layer as uniformly as possible over the entire substrate surface.

Usually, in forming metallization layers by the so-called damascene technique, vias and trenches, previously patterned into a dielectric layer, are filled with metal and a certain degree of excess metal has to be provided to reliably fill the vias and trenches. Subsequently, the excess metal has to be removed to ensure electrical insulation between adjacent trenches and vias and to provide a planar surface for the formation of further metallization layers. A frequently employed technique for removing excess metal and planarizing the substrate surface includes chemical mechanical polishing (CMP), in which the surface material to be removed is subjected to a chemical reaction and is simultaneously mechanically removed. It turns out, however, that chemically mechanically polishing a patterned surface provided on a large diameter substrate is per se an extremely complex process. The problems involved in the CMP process are even exacerbated when the thickness of the metal layer to be removed varies across the surface of the substrate. Typically, the CMP process may exhibit a certain intrinsic non-uniformity, depending on the type of materials to be removed and the specific process conditions and the like, and the combined non-uniformity of the metal deposition process and the CMP process may result in unacceptable variations of the finally obtained metal trenches and vias. For example, a typical electroplating process is performed by first forming a seed layer on the surface intended to receive the metal, wherein the seed layer acts as a current distribution layer during the actual electrochemical deposition process, during which the seed layer is connected to the cathode and serves as a conductor for the current flowing from an anode within the reactor through the electrolyte solution in the reactor to the cathode. At least during the initial phase, in which only minute amounts of metal have already been deposited on the seed layer, the local current flow and thus the local deposition rate is significantly affected by the characteristics of the seed layer, such as thickness uniformity, step coverage and the like. Moreover, since the seed layer is typically contacted at the substrate perimeter, the resistivity of the seed layer increases from the substrate perimeter to the substrate center, thereby causing a potential drop, which in turn results in a reduced deposition rate. Consequently, there is a tendency for an increased metal thickness at the substrate edge, whereas the substrate centre may exhibit a reduced metal thickness.

As explained above, the removal of any excess metal after filling trenches and vias may, in currently preferred technologies, involve the chemical mechanical polishing of the substrate, wherein this process may typically have an intrinsic non-uniformity, in which material at the substrate center may be removed more rapidly than material at the wafer periphery. Therefore, the combination of the deposition non-uniformity and the CMP non-uniformity may result in a significant degradation of trenches and vias in the substrate center, owing to a high degree of over-polish experienced by these circuit features, while the circuit elements at the substrate periphery remain substantially unaffected. As a consequence, great efforts are being made to significantly reduce or adapt process non-uniformities of the electrochemical deposition of metals.

With reference to FIG. 1, a typical prior art electroplating system will now be described in more detail in order to illustrate the problems involved in electrochemically depositing a metal, such as copper.

In FIG. 1, a system 100 for electrochemically treating a substrate 130 is illustrated in a simplified schematic manner, wherein the system 100 is to represent an electroplating reactor for depositing a metal on a surface 131 of the substrate 130, which is conveyed and held in position by a movable substrate holder 120. The system 100 further comprises a reactor bowl 110 for containing an electrolyte solution 102 that may include any chemical agents required for depositing a metal on the surface 131 upon the initiation of a current flow through the electrolyte solution 102. The reactor bowl 110 may further comprise a supply line 103 and an exhaust line 104 for introducing the electrolyte solution 102 with a specified flow rate and for removing excess solution from the reactor bowl 110. The supply line 103 and the exhaust line 104 may be coupled to a storage and recirculation assembly 105, which is configured to provide electrolyte solution to be supplied to the reactor bowl 110 and to receive the excess solution via the exhaust line 104. It should be appreciated that the storage and recirculation assembly 105 may include any equipment as is required for the operation of the system 100, such as circulation pumps, filters, storage tanks and the like.

Furthermore, the reactor bowl 110 has contained therein an electrode 106, which may be comprised of two or more individual electrode portions, depending on the specific device design. Typically, an electrode with multiple electrode portions may provide the opportunity for a more flexible control of the current flow within the electrolyte solution 102 during operation of the system 100. It should be appreciated that the electrode 106 may substantially act as an anode, when the system 100 represents a metal deposition system, wherein, however, typical process recipes for forming metallization layers in advanced microstructures require highly complex current pulse sequences, in which the electrode 106 may temporarily act as the cathode. During such a mode of operation, the averaged current-time integral, however, identifies the electrode 106 as the anode during a deposition process due to a positive sign, while, for a removal process, the electrode may be identified as the cathode based on the resulting negative sign of the current-time integral.

Typically, a diffuser 107 is provided within the reactor bowl 110 to allow efficient control of electrolyte flow from the electrode 106 to the substrate surface 131. For instance, the diffuser 107 may comprise a plurality of passages to locally control the electrolyte flow in a desired manner. For example, as previously explained, the diffuser 107 may allow an increased electrolyte flow through the center thereof to increase the deposition rate at the center of the substrate 130.

Moreover, typically, a shield 108 is provided within the reactor bowl 110 in the vicinity of the substrate 130 during operation, which may, depending on the overall system design, be attached to the reactor bowl 110 at a fixed position, or which may be attached to the moveable substrate holder 120. In the embodiment shown, the shield 108 may be attached to the sidewall of the reactor bowl 110 to influence the electrolyte flow especially at the substrate perimeter, thereby shielding the electrostatic potential, which, without the shield 108, may be higher at the substrate perimeter compared to the substrate center due to a potential drop caused by the non-uniform radial resistivity of a seed layer 132 provided at the substrate surface 131.

During operation of the system 100, the substrate 130 is loaded into the substrate holder 120 at a remote position by any appropriate automatic substrate handling device. Thereafter, the substrate holder 120, which is driven by any appropriate drive assembly (not shown), is then moved to the reactor bowl 110 to bring into contact the substrate surface 131 with a liquid surface or meniscus 102a, which is established within the reactor bowl 110 by initiating an electrolyte flow via the storage and recirculation assembly 105, the supply line 103 and the exhaust line 104. Depending on the reactor design, the exact position of the surface 102a may slightly vary and the substrate holder 120 is moved in a vertical direction, indicated by arrow 121, to identify a desired operating position at which the substrate surface 131 is reliably in contact with the electrolyte 102. Determining the position of the surface 102a and thus of a desired operating position of the substrate holder 120 may frequently be performed manually by an operator who observes in a step-wise motion towards the electrolyte 102 the position of a reliable contact between the substrate surface 131 and the electrolyte 102. In other procedures, the current flow through the electrolyte 102 may be observed to determine the time at which the substrate 131 contacts the electrolyte fluid 102. Moreover, during and/or after positioning the substrate holder 120 relative to the surface 102a, the substrate holder 120 may be rotated, as indicated by arrow 122, to reduce any axial non-uniformities during the further processing of substrate 130.

When the substrate holder 120 is in the operating position, the actual deposition process is initiated by applying a specified current pulse sequence between the electrode 106 and the substrate surface 131, which acts as the counter electrode. During this deposition process, a distance 109 between the two electrodes, i.e., the electrode 106 and the “counter electrode” 131, is a highly sensitive deposition parameter as the distance 109 globally determines the electric field and thus the so-called throwing power of the deposition process, which in turn substantially affects the deposition uniformity across the substrate 130. Consequently, as the above procedure for determining the position of the surface 102a may be quite inaccurate and may also be time-consuming, the system 100 may suffer from a reduced deposition accuracy and throughput. Moreover, in many electrochemical systems, such as the system 100, consumable electrodes are used so that a significant thickness variation at the electrode 106 may occur after the processing of a plurality of substrates. Hence, the previously determined distance 109 may vary, thereby also contributing to a reduced deposition accuracy.

As previously explained, process parameters of the deposition process may be adjusted to obtain a specified thickness profile across the substrate surface 131 to take into consideration the non-uniform characteristics of a subsequent CMP process. Thus, any process fluctuations during the deposition process may also significantly affect subsequent processes, thereby possibly compromising structural features produced by the subsequent processes, such as metal trenches and the like.

In view of the above situation, there is a need for an improved technique that enables the electrochemical treatment of substrates at a higher degree of accuracy and/or a higher degree of process flexibility and/or a higher throughput.

### SUMMARY OF THE INVENTION

The following presents a simplified summary of the invention in order to provide a basic understanding of some aspects of the invention. This summary is not an exhaustive overview of the invention. It is not intended to identify key or critical elements of the invention or to delineate the scope of the invention. Its sole purpose is to present some concepts in a simplified form as a prelude to the more detailed description that is discussed later.

Generally, the present invention is directed to a technique that significantly facilitates the processing of substrates during an electrochemical treatment, such as electroplating, electropolishing, electroless plating and the like, in that the positioning of the substrates is performed with enhanced accuracy and in a highly automated fashion.

According to one illustrative embodiment of the present invention, a system comprises a reactor assembly configured to contain an electrolyte solution for an electro-chemical treatment of a surface of a substrate. The system further comprises a substrate holder configured to receive the substrate and hold the substrate in an operating position that is selected to bring the electrolyte solution into contact with the substrate surface. Moreover, the system comprises an electric drive assembly that is operatively coupled to the reactor assembly and the substrate holder and that is configured to move the substrate surface relative to the electrolyte solution. Finally, the system comprises a control unit connected to the electric drive assembly and configured to determine at least one reference position of the substrate holder on the basis of a signal generated by the electric drive assembly.

In accordance with another illustrative embodiment of the present invention, a method comprises moving a substrate holder relative to an electrolyte bath to contact a surface of the electrolyte. Additionally, the method comprises monitoring, when moving the substrate holder, a signal of an electric drive assembly that is used to move the substrate holder. Finally, the method comprises determining a reference position on the basis of the signal monitored.

### BRIEF DESCRIPTION OF THE DRAWINGS

The invention may be understood by reference to the following description taken in conjunction with the accompanying drawings, in which like reference numerals identify like elements, and in which:

FIG. 1 schematically shows a conventional electroplating system for depositing a metal onto a substrate surface;

FIG. 2 schematically shows a system for the electrochemical treatment, such as electroplating, electropolishing and the like, of a substrate surface in accordance with illustrative embodiments of the present invention; and

FIG. 3 schematically shows a manufacturing system including an electrochemical station and a measurement station, wherein an automatic initialization of the electrochemical station is triggered by measurement results of a downstream measurement system.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

### DETAILED DESCRIPTION OF THE INVENTION

Illustrative embodiments of the invention are described below. In the interest of clarity, not all features of an actual implementation are described in this specification. It will of course be appreciated that in the development of any such actual embodiment, numerous implementation-specific decisions must be made to achieve the developers' specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

The present invention will now be described with reference to the attached figures. Various structures, systems and devices are schematically depicted in the drawings for purposes of explanation only and so as to not obscure the present invention with details that are well known to those skilled in the art. Nevertheless, the attached drawings are included to describe and explain illustrative examples of the present invention. The words and phrases used herein should be understood and interpreted to have a meaning consistent with the understanding of those words and phrases by those skilled in the relevant art. No special definition of a term or phrase, i.e., a definition that is different from the ordinary and customary meaning as understood by those skilled in the art, is intended to be implied by consistent usage of the term or phrase herein. To the extent that a term or phrase is intended to have a special meaning, i.e., a meaning other than that understood by skilled artisans, such a special definition will be expressly set forth in the specification in a definitional manner that directly and unequivocally provides the special definition for the term or phrase.

Generally, the present invention is based on the concept that an enhanced degree of accuracy in the electrochemical treatment of a substrate may be accomplished in that the positioning of a substrate relative to an electrode contained in the electrolyte solution is substantially determined in an automated fashion, thereby significantly reducing any process variations that may be caused by a manual or semi-automatic positioning method. As previously explained, a plurality of process parameters in the electrochemical treatment of a substrate are involved, which may contribute to the finally obtained deposition profile. For example, diffuser elements and shields for manipulating the electrolyte flow and the electric field within the electrolyte, that is, between the substrate surface and an electrode immersed into the electrolyte solution, may typically be employed and adjusted to obtain a desired overall deposition treatment profile. These process parameters may, however, vary even though the diffuser shape and configuration, as well as the position and shape of any shield elements, may be controlled in a highly precise fashion, since the effective electric field distribution is highly sensitive to the distance between the electrodes and thus significantly depends on the accuracy of the initial positioning of the substrates for a large number of substrates and for varying process conditions when, for instance, a consumable electrode is used.

Consequently, in the present invention, it is contemplated to provide a technique that enables a highly automated way of positioning the substrate with respect to the immersed electrode to achieve highly stable process conditions. For this purpose, signals generated by electric drive assemblies as are typically used in electrochemical reactors for conveying, positioning and rotating substrates may be monitored and evaluated to obtain reliable positioning data, which may then be used in determining a desired initial operating position. Thus, one or more electric motors of the drive assembly may additionally be used as “position sensors” for determining a stable operating position on the basis of a reference position, wherein, in some embodiments, the continuous wear of a consumable electrode may be taken into consideration.

Thus, the present invention is highly advantageous in combination with any electro-chemical treatment used in the fabrication of microstructures, and in particular embodiments, of integrated circuits requiring a reliable and reproducible deposition of metal onto a substrate surface including a patterned dielectric layer which may comprise thereon a conductive seed layer. It should be appreciated that the present invention is advantageous in combination with the electrochemical deposition of metals, such as copper, copper-based alloys, solder material and the like. In other cases, the electrochemical treatment of a substrate may refer to the electrochemical removal of a metal from a substrate surface, also referred to as electropolishing, which may be considered as substantially the inverse process of electroplating. Thus, unless otherwise referred to in the following detailed description as well as in the appended claims, an electrochemical treatment is to be understood as the electrochemical deposition or removal of a metal by means of an electrolyte solution that is to be brought into contact with the substrate surface under consideration.

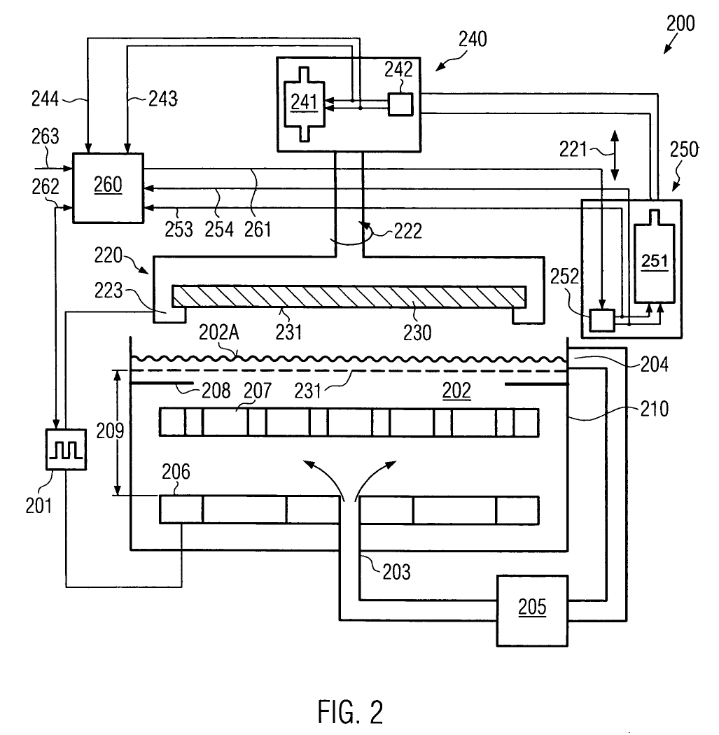

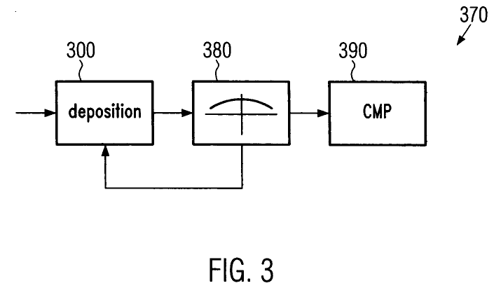

With reference to FIGS. 2 and 3, further illustrative embodiments of the present invention will be described in more detail. FIG. 2 schematically shows a system 200 for the electrochemical treatment of a substrate surface 231 of a substrate 230. The system 200 comprises a reactor assembly 210, which may substantially be provided in the form of a reactor bowl, configured to contain a specified electrolyte solution 202. The reactor assembly 210 may further comprise an input line 203 and an exhaust line 204, which are connected to a storage and recirculation assembly 205. It should be appreciated that the reactor assembly 210 may have, in other embodiments (not shown), a different configuration such as an inner tank and an exhaust tank which may communicate with each other by a respective communication line, wherein the exhaust tank receives any excess electrolyte solution from the inner tank, which may then be re-circulated, if required, into the inner tank. Moreover, although the embodiment depicted in FIG. 2 represents a fountain-type reactor assembly, other types of reactors, such as fountain reactors supplying a predefined amount of electrolyte solution into the actual process chamber, which may correspond to the reactor assembly 210, or any other bath-type reactors may be used as well in combination with the present invention.

The reactor assembly 210 may further comprise a diffuser element 207 having a specified configuration and shape to create a desired flow pattern within the electrolyte 202: Hereby, the configuration and effective shape of the diffuser element 207 may be variable to provide the potential for obtaining different deposition or treatment profiles with a single diffuser element. Moreover, the reactor assembly 210 may comprise a shield element 208 to control the deposition rate at a perimeter of the substrate 230. Furthermore, a current supply 201 is provided and is connected to an electrode 206 and to a substrate holder 220, which may position and hold the substrate 230 during operation of the system 200.

A first drive assembly 240 is mechanically coupled to the substrate holder 220 and is configured to rotate the substrate holder 220 within a range of zero to several hundred revolutions per minute, as is indicated by arrow 222. The drive assembly 240 comprises an electric motor 241 coupled to a motor control unit 242, which is configured to supply power to motor 241 in a controllable fashion. Moreover, the substrate holder 220 is mechanically coupled to a second drive assembly 250 comprising an electric motor 251 and a motor control unit 252, which is configured to supply power to the motor 251 in a controllable fashion. The drive assembly 250 is adapted to vertically move the substrate holder 220, as is indicated by arrow 221.

The system 200 further comprises a control unit 260, which is operatively coupled to the second drive assembly 250 and, in one illustrative embodiment, is also operatively coupled to the first drive assembly 240. In this respect, the term “operatively coupled” to the drive assembly 250 and possibly to the drive assembly 240 means that the control unit 260 is configured to receive a signal that is indicative of the status of the respective drive assemblies 240, 250. In one illustrative embodiment, the motor 251 may represent a brushless DC motor, a DC motor, or any other suitable electric motor, and the control unit 260 may receive signals 253 and/or 254, which are representative for the supply voltage and/or the supply current delivered by the motor control unit 252. Consequently, the signal 253 and/or 254 may be used to evaluate the momentary status of the motor 251, wherein this information may be used in determining positional data regarding the substrate holder 220, as will be discussed in more detail later on. In other embodiments, the motor control unit 252 may directly provide respective signals indicating the status of the drive assembly 250. For instance, the drive assembly 250 may comprise a rotary decoder providing a signal depending on the rotary position of the motor 251. Similarly, the drive assembly 240 may be connected to the control unit 260 to provide one or more signals 243, 244 indicating the momentary status of the drive assembly 240. Again, any criteria described with reference to the drive assembly 250 also apply for the drive assembly 240.

Moreover, the control unit 260 may comprise any hardware and software resources, such as a microprocessor including an appropriate instruction set, and/or any other digital and/or analog circuitry so as to process one or more signals received from the drive assembly 250 and possibly from the drive assembly 240 to estimate positional data and to generate at least one control signal 261, which may be provided at least to the motor control unit 252 of the drive assembly 250.

In some particular embodiments, the control unit 260 is also operatively connected to the current supply 201 to receive at least a signal 262 indicating the momentary current flow within the reactor assembly 210. Furthermore, in one illustrative embodiment, the control unit 260 may be configured to receive information 263 on the status of the electrode 206. In this respect, information on the momentary status of the electrode 206 may include one or more of the following pieces of information: a size and dimension of the electrode 206, the removal rate for specified operating conditions especially when the electrode 206 is a consumable electrode, an accumulated operating time of the electrode 206, wherein the accumulated operating time may include the specific operating conditions over time, and the like.

During operation of the system 200, the substrate 230 having a surface 231 to be electrochemically treated is loaded into the substrate holder 220, wherein the substrate holder 220 may be moved to an appropriate load and unload position (not shown). Moreover, as previously explained, the substrate surface 231 may have been pretreated so as to comprise a seed layer (not shown) acting as a current distribution layer and thus as an electrode during the subsequent electrochemical process. Thereafter, the substrate holder 220 is moved into a position to allow contact with the electrolyte 202 by vertically moving the substrate holder 220 by means of the drive assembly 250. As previously noted, a surface 202a of the electrolyte, also referred to as meniscus, may slightly vary, depending on the reactor design and the process parameters. Thus, in one illustrative embodiment, the substrate holder 220 may be lowered into the reactor assembly 210 in such a way that the substrate surface 231 is reliably brought into contact with the electrolyte 202. For this purpose, the shield 208 may serve as a stop element for the vertical motion 221 of the substrate holder 220, wherein one or more of the signals 253, 254 may be monitored by the control unit 260 to detect the time of contacting the shield 208, for instance on the basis of an increase in motor current.

It should be appreciated that, in other embodiments, the shield 208 may be attached to the substrate holder 220 to provide a substantially constant distance between the substrate surface 231 and the shield 208. In this case, a designated stop element (not shown) may be provided in addition to the now-movable shield 208 at a well-defined position within the reactor assembly 210 to restrict the range of motion of the substrate holder 220. Upon contact of the substrate holder 220 with the stop element or shield 208, the motor current of the motor 251 may significantly increase, which may be detected by the control unit 260, which may now identify the current position of the substrate holder 220 as the “reference position” defined by the stop element or shield 208. In some embodiments, the corresponding motion of the substrate holder 220 is performed at moderately low speed, at least in the vicinity of the reference position, the location of which may at least coarsely be known to the control unit 206, wherein then the control unit 260 may instruct the drive assembly 250 to reduce motor speed via the control signal 261 transmitted to the motor control unit 252. In one embodiment, during this moderate low operating speed of the substrate holder 220, the point in time may be recorded by the control unit 260, at which a current flow is first established thereby indicating a contact of the substrate holder 220 with the meniscus 202a of the electrolyte 202. Upon detection of a corresponding current flow, the current supply 201 may, in one illustrative embodiment, be disabled to avoid a treatment, for instance a deposition of metal on the substrate surface 231 upon contact with the electrolyte 202 during the further motion of the substrate holder 220 towards the reference position. Moreover, upon detection of a first current flow, one or more of the signals 253 and 254 may be recorded and/or evaluated to obtain a measure for the distance to the reference position, which will be reached upon contacting the stop element or shield 208. For example, upon a first current flow, which may then immediately be disabled, the time and the operating condition, for instance current and/or voltage supplied to the motor 251, may be sampled so as to have corresponding “electrical position data” as a measure of the distance, with which the substrate holder 220 is moved further after the initial current flow.

Upon reaching the reference position, which may be detected by an increase of the motor current due to a blockade of the rotary motion thereof, the position of the meniscus 202a with respect to the reference position may be determined, at least in the form of the electrical data delivered by the drive assembly 250. In some embodiments, these “electrical position” data may be converted into actual positional data by providing a relationship between the rotary motion of the motor 251, which may precisely be determined by the electric power supplied thereto, and the vertical motion 221 carried out by the substrate holder 220 for a given rotary motion of the motor 251. Corresponding “actual” positional data may then be calculated and indicated to an operator and/or to a superior control system and the like. It should be appreciated, however, that any further processing of the data provided by the drive assembly 250 may be performed in any appropriate format so that a conversion of electrical position data into actual positional data may not be required.

In one embodiment, the control unit 260 may be configured to convert the electrical data provided by the drive assembly 250, which refer to a first specified operating condition of the motor 251, into other electrical data referring to a different operating state of the motor 251. Accordingly, based on this conversion, the motor 251 may be operated at a different speed, for instance when positioning subsequent substrates, while the data conversion ensures nevertheless a correct positioning of the substrate holder 220, although the operating position has been established on the basis of the initial electrical data.

After reaching the reference position, a desired operating position may then be determined on the basis of the electrical data defining the position of the meniscus 202a. It should be appreciated that the “detected” position of the meniscus 202a, on the basis of the electrical data of the drive assembly 250 and the current supply 201, may not necessarily represent an optimum operating position since, as previously explained, the time of a first current flow may have been detected upon contact of a lower portion or a contact ring 223 with the electrolyte 202 even without substantially wetting the surface 231. Hence, a desired operating position of the substrate holder 220 may be defined by a specified offset from the detected position of the meniscus 202a. Moreover, since a reliable operating position, ensuring a reliable wetting of the substrate surface 231, also requires a substantially constant distance between the electrode 206 and the substrate surface 231, the actual operating position may also be determined on the basis of the reference position defined by the stop element or shield 208.

In other embodiments, when the position of the meniscus 202a is substantially determined by structural characteristics of the reactor assembly 210, the operating position may be determined on the basis of the reference position of the shield 208, obtained by monitoring of the signals 253, 254, and a specified offset, wherein the offset then determines the finally obtained distance between the substrate surface 231 and the electrode 206. For example, the substrate holder 220 may, after reaching the reference position at the stop element 208, be moved upwards with specified operating conditions of the motor 251 in accordance with a specified offset so as to reach the operating position, thereby obtaining a well-defined distance 209 of the immersed surface 231 with respect to the electrode 206. As previously explained, the “offset data” for reaching the operating position may be provided in the form of a control signal 261 specifying predefined operating conditions for the motor 251, such as a specified voltage and/or current supplied thereto, and a specified time period, for which these operating conditions of the motor 251 are maintained.

In other embodiments, the “offset data” may be provided in a more general form, such as dimensional data and the like, which may then be converted into the corresponding electrical data for the motor 251 on the basis of any conversion algorithm implemented in the control unit 260. For instance, for typical servo motors, a precise relationship between the electrical power supplied to the motor and the mechanical output of the motor exists, which allows a corresponding conversion of electrical data into mechanical, that is, dimensional data, and vice versa. Upon reaching the operating position, that is, reaching the specified distance 209 between the electrode 206 and the substrate surface 231, the actual treatment may be initiated, for instance by correspondingly instructing the current supply 201 to establish a current flow in accordance with the process recipe under consideration. Consequently, the operating position may be achieved with high reliability and reproducibility for a large number of substrates in an automated fashion, even if the position of the meniscus 202a may have to be determined to determine an appropriate operating position with respect to the position of the meniscus 202a.

In other illustrative embodiments, the drive assembly 240 may additionally or alternatively be used in identifying the reference position at the stop element 208. For this purpose, the substrate holder 220 may be rotated by the drive assembly 240 and may then be lowered until the rotating movement of the substrate holder 220 is affected upon contacting the stop element or shield 208. At this time, a corresponding increase of the motor current may be detected on the basis of one or more of the signals 243, 244, thereby reliably indicating the arrival of the substrate holder 220 at the reference position. Thereafter, the substrate holder 220 may be retracted by means of the drive assembly 250, wherein the retracting movement may be performed on the basis of offset data to position the substrate surface 231 at a desired operating position. In other embodiments, a minor change of the operating state of the motor 241 may be detected upon contact with the meniscus 202a due to the additional friction caused by the electrolyte 202. Thus, in addition or alternatively to the detection of the beginning of a current flow through the electrolyte 202, one or more of the signals 243, 244 may be used as sensor signals to detect the contact of the substrate 230 with the electrolyte 202 by measuring the increase of the motor current, a reduction of the rotational speed and the like caused by the transition from air to fluid. Hence, the motor 242 may be used as a “sensor element” for detecting either the time of contacting the meniscus 202a or the stop element 208 or both, wherein simultaneously the electrical data 253, 254 from the motor 251 may be used as positional data for the vertical movement 221.

Similarly, in some embodiments, the drive assembly 250 may be used as “meniscus sensor” by monitoring the signals 253, 254 with respect to a slight increase of the motor current due to the abrupt increase in friction upon contacting the meniscus 202a. Moreover, two or more of the above “sensor schemes” may be used in combination to enhance the overall accuracy. For example, detecting the reference position and/or the meniscus position may be performed by simultaneously monitoring the drive assembly 240 and the drive assembly 250.

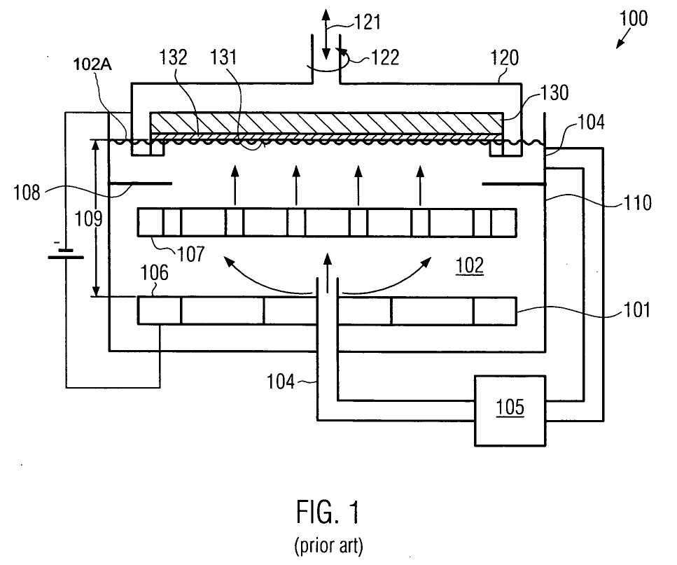

The embodiments described above may be advantageous when conventional plating systems, such as the system 100 described with reference to FIG. 1, may be used in combination with the present invention. Hence, in this case, the control unit 260 may be provided as a separate unit and may be connected to the respective drive assemblies (not shown in FIG. 1) so as to obtain therefrom the required electrical data. Consequently, only minor additional efforts in re-designing the existing hardware configuration of the conventional plating tool are required. In other embodiments, the drive assembly 250 may comprise precise decoders or step motors, which may be able to provide accurate signals with respect to a predefined absolute position, such as an end position for the vertical movement 221, which may then be used as the reference position for determining the position of the meniscus 202a and/or an appropriate operating position having a specified distance 209.

As previously explained, many electrochemical processes require the provision of a consumable electrode for the electrode 206, resulting in a significant material removal or material accumulation, after the processing of a plurality of substrates. As a consequence, the distance 209 from the electrode 206 in its current status may significantly vary after a plurality of substrates, when the current operating position with respect to the reference position is maintained. However, a corresponding variation, that is, an increase of the distance 209 for an electroplating process due to electrode wear or a decrease of the distance 209 for an electropolishing process, may result in a different throwing power, thereby significantly influencing the overall deposition profile. Moreover, depending on the design of the reactor assembly 210, a varying thickness of the electrode 206 may result in a varying position of the meniscus 202a, for instance when a substantial amount of electrolyte per time unit is supplied to the interior of the reactor assembly 210. Thus, when the operating position is selected close to the meniscus 202a, a re-adjustment of the operating position is necessary to avoid irregular deposition conditions when the position of the meniscus becomes lower over time.

Hence, in some illustrative embodiments, the control unit 260 receives the information 263 indicating the momentary status of the electrode 206, which may enable the control unit 260 to predict material removal or material accumulation and thus estimate a variation of the distance 209 with respect to the currently valid operating position. For instance, the control unit 260 may receive data on the current flowing through the electrolyte 202 and may also monitor and record the duration of each process period with specified current conditions. Based on this information and the current dependent removal rate or accumulation rate for the electrode 206, the control unit 260 may estimate a corresponding thickness variation of the electrode 206 and thus a corresponding variation of the distance 209. Based on the estimated thickness variation or variation of the distance 209, an updated operating position may be determined and a corresponding control signal 261 may be generated and applied to the drive assembly 250. For instance, in a process flow in which the substrate holder 220 is lowered down to the reference position and is then raised with a specified offset to reach the desired operating position, the specified offset may be updated on the basis of the estimated thickness or distance variations. Hence, the distance 209 may be maintained substantially constant within a predefined process tolerance.

In other embodiments, the position of the meniscus 202a may be determined, as is for instance described above, when the meniscus position is related to the momentary thickness of the electrode 206. Consequently, highly stable conditions for the electrochemical treatment of a large number of substrates may be maintained in a highly automated fashion, wherein an updating of the operating position may be initiated by the controller unit 260 by an operator or by any supervising control system (not shown).

FIG. 3 schematically shows a process sequence 370 including a plurality of process stations with a station 300 for electrochemically treating a substrate, wherein the station 300 may be similar to the system 200 as described with reference to FIG. 2. Moreover, the sequence 370 may comprise a measurement station 380, which is configured to determine a global profile of the substrate after having been processed by the station 300. In one particular embodiment, the station 300 may represent an electroplating station operated by process parameters that generate a desired deposition profile, which is tailored for a subsequent CMP station 390 to achieve superior microstructures after the chemical mechanical polishing in the station 390. For instance, the electroplating station 300 may be adjusted to provide a dome-shaped profile, that is, an increased layer thickness at the center of the substrate to compensate for a “center fast” behavior of the CMP station 390. Upon detection of a deviation from the desired deposition profile in the measurement station 380, the station 380 may instruct the deposition station 300 to perform a re-initialization of the deposition station, that is to re-determine an appropriate operating position for the substrate, as is described with reference to FIG. 2. Thus, any deviations of the deposition profile caused by, for instance, a misaligned operating position, for instance causing a non-appropriate distance 209 of the substrate surface 231 with respect to the electrode 206 (FIG. 2), may substantially be compensated for by correspondingly resetting the electroplating station 300.

In other embodiments, the measurement results obtained by the measurement station 380 may be used, possibly in combination with process information 263 (FIG. 2), to update the current operating position, for instance by updating a corresponding offset, as is previously described with reference to FIG. 2, without re-initializing the station 300. Consequently, the overall accuracy of the process sequence 370 may be enhanced, while at the same time the throughput may be increased since time-consuming and substantially inaccurate manual or semi-automatic initialization procedures for determining the operating position may be avoided.

In some of the embodiments described above, it is referred to fountain-type reactors having one electrode indicated as “anode” in a deposition regime that is placed at the bottom of the reactor while the substrate, acting as the counter electrode, is placed at the top of the reactor bowl. In other embodiments, the reactor bowl may be configured to have the substrate positioned at the bottom, wherein the other electrode, that is the “anode” is closing in from the top of the reactor bowl. Thus, the positioning of the anode may be performed in the same way as is described for the substrate in the preceding embodiments.

In still other embodiments, the substrate and the electrode of the reactor bowl, that is, the anode in a deposition regime, may be arranged in parallel to each other in a substantially upright configuration. Hereby, the positioning of the substrate with respect to the electrode may be performed in substantially the same way as previously described. That is, the substrate may be moved to a reference position, which may be defined by a shield or a stop element and is then moved to the operating position on the basis of the detected reference position.

As a result, the present invention provides an improved system and a method for electrochemically treating a substrate, wherein the operating position of the substrate may be determined in an automated fashion with high accuracy, wherein signals from one or two electrical drive assemblies may be used in appropriately positioning the substrate with respect to the electrode. Consequently, highly stable process conditions may be maintained, in particular when a consumable electrode is used, since the momentary status of the electrode may be taken into consideration when determining a desired operating position of the substrate. Consequently, the continuous change of the electrode status may be estimated on the basis of an integrated current flow and/or on the basis of experimental data and/or theoretical models. Based on the momentary status of the electrode, a substantially continuous updating of an appropriate operating position may be carried out. In other embodiments, a re-determination of an appropriate operating position may be performed on the basis of measurement results indicating the surface profile of substrates previously processed by the system, thereby providing an automatic resetting of the system.

The particular embodiments disclosed above are illustrative only, as the invention may be modified and practiced in different but equivalent manners apparent to those skilled in the art having the benefit of the teachings herein. For example, the process steps set forth above may be performed in a different order. Furthermore, no limitations are intended to the details of construction or design herein shown, other than as described in the claims below. It is therefore evident that the particular embodiments disclosed above may be altered or modified and all such variations are considered within the scope and spirit of the invention. Accordingly, the protection sought herein is as set forth in the claims below.

What is claimed:

1. A system, comprising:
a reactor assembly configured to contain an electrolyte solution for electrochemical treatment of a surface of a substrate;
a substrate holder configured to receive said substrate and hold said substrate in an operating position for bringing said electrolyte solution into contact with said substrate surface;
an electric drive assembly operatively coupled to said reactor assembly and said substrate holder and configured to move said substrate surface relative to said electrolyte solution; and
a control unit connected to said electric drive assembly and configured to determine at least one absolute position of said substrate holder on the basis of a signal generated by said electric drive assembly.

2. The system of claim 1, wherein said drive assembly comprises a lift motor configured to move said substrate holder into and out of contact with said electrolyte solution, and wherein said control unit is configured to evaluate a supply signal supplied to said lift motor by said electric drive assembly.

3. The system of claim 2, wherein said control unit is configured to evaluate a value indicative of a torque of said lift motor.

4. The system of claim 1, wherein said drive assembly comprises a rotation motor configured to rotate said substrate holder and wherein said control unit is configured to evaluate a supply signal supplied to said rotation motor by said electric drive assembly.

5. The system of claim 4, wherein said control unit is configured to evaluate a value indicative of a torque of said rotation motor.

6. The system of claim 1, wherein said reactor assembly comprises a bowl for containing said electrolyte solution and a stop element at an internal sidewall thereof, said stop element restricting a range of motion of said substrate holder.

7. The system of claim 6, wherein said stop element is at least a portion of a shield for controlling a deposition behavior at a perimeter region of said substrate.

8. The system of claim 6, wherein said control unit is configured to evaluate a value indicative of a torque of said lift motor.

9. The system of claim 6, wherein said control unit is configured to evaluate a value indicative of a torque of said rotation motor.

10. The system of claim 1, wherein said control unit is further configured to generate a control signal on the basis of said at least one absolute position and a specified offset from said absolute position, said control signal being configured to cause said electric drive assembly to move said substrate holder to said offset position.

11. The system of claim 10, wherein said control unit is further configured to determine a contact position at which said substrate surface contacts a liquid surface of said electrolyte solution.

12. The system of claim 11, wherein said control unit is further configured to receive status information indicating a current status of a consumable electrode arranged in said reactor assembly and to determine said specified offset on the basis of said status information.

13. The system of claim 1, wherein said reactor assembly comprises a reactor bowl that is configured to receive said substrate at a bottom of said bowl.

14. The system of claim 1, wherein said reactor assembly comprises a reactor bowl, said bowl including an electrode that is arranged in a substantially upright configuration.

15. A method, comprising
moving a substrate holder relative to an electrolyte bath so as to contact a surface of said electrolyte;
monitoring, during moving said substrate holder, a signal of an electric drive assembly used to move said substrate holder; and
determining a reference position on the basis of said monitored signal.

16. The method of claim 15, further comprising determining a meniscus position of said electrolyte surface at least on the basis of said monitored signal.

17. The method of claim 16, further comprising moving said substrate holder to said reference position and using a value of said monitored signal at said reference position to determine said meniscus position.

18. The method of claim 15, further comprising receiving a signal indicating a conductivity between said substrate holder and said electrolyte.

19. The method of claim 15, wherein said reference position is defined by a boundary of a range of motion of said drive assembly.

20. The method of claim 19, wherein said boundary is defined by a stop element within a reactor bowl.

21. The method of claim 16, further comprising receiving status information on an electrode contained in said electrolyte and determining a relative distance between said meniscus position and said electrode based on said status information.

22. The method of claim 21, further comprising moving said substrate holder relative to said electrode to adjust an operating position having a distance of said substrate holder to said electrode within a specified range, wherein moving said substrate holder to said operating position is controlled on the basis of said relative distance.

23. The method of claim 22, wherein said electrode is a consumable electrode and said status information comprises information on the removal rate for at least one specified operating condition.

24. The method of claim 15, wherein said monitored signal at said reference position is a supply signal for one or more electric motors of said electric drive assembly.

25. The method of claim 22, further comprising processing one or more of first substrates at said operating position, determining an updated operating position on the basis of said status information, and processing one or more second substrates at said updated operating position.
